(19) United States
(12) Patent Application Publication
(10) Pub. No.: US 2016/0303880 A1
(43) Pub. Date: Oct. 20, 2016

(54) METHOD FOR MANUFACTURING AND DETECTING ANTI-COUNTERFEITING MARK AND ANTI-COUNTERFEITING IMPLEMENT USING THE SAME

(71) Applicant: National Yang-Ming University, Taipei (TW)

(72) Inventors: Surojit CHATTOPADHYAY, West Bengal (IN); Chia-Min WANG, New Taipei City (TW)

(21) Appl. No.: 14/742,079

(22) Filed: Jun. 17, 2015

(30) Foreign Application Priority Data
Apr. 17, 2015 (CN) 104112445

(51) Int. Cl. B41M 3/14

(52) U.S. Cl. CPC B41M 3/14

(57) ABSTRACT

A method of manufacturing and detecting an anti-counterfeiting mark includes steps as follows. For manufacturing an anti-counterfeiting mark, a first ink, which has a contrast enhancer and a lecithin solution with a first concentration, is provided. Then, the first ink is used for drawing an anti-counterfeiting mark on a target object. For detecting the anti-counterfeiting mark, a second ink, which has a chloroauric acid solution having a second concentration, is provided. Then, the second ink is applied onto the target object to form a plurality of gold nanoparticles on the surface of the anti-counterfeiting mark. Further, a tool implementing the above method is also included.

This Non-provisional application claims priority under 35 U.S.C. §119(a) on Patent Application No(s). 104112445 filed in Taiwan, Republic of China, Apr. 17, 2015, the entire contents of which are hereby incorporated by reference.

### BACKGROUND OF THE INVENTION

1. Field of the Invention

This invention relates to a method for manufacturing and detecting an anti-counterfeiting mark by reducing gold nanoparticles on the surface of the anti-counterfeiting mark, and an anti-counterfeiting implement using the same. It provides a kind of three-stage anti-counterfeiting technology.

2. Description of the Related Art

The proliferation of counterfeiting is a worldwide problem that is hard to eradicate. Products counterfeited by illegal manufacture not only detrimentally affect market prices, but can also harm the health or even the life of members of the public. Thus, prohibiting the counterfeiting of products has become an urgent issue for companies to address.

In an effort to combat counterfeiting, many companies may attach anti-counterfeiting tags to their products. These tags can assist in distinguishing whether a product is legitimate. Laser anti-counterfeiting tags are a common type of anti-counterfeiting tag. These tags will display different patterns or colors when exposed to different angles of light. However, because lithography technology needed to make such tags has become common, the effectiveness of such anti-counterfeiting tags has been diminished. A laser anti-counterfeiting tag may be scanned in at high resolution and then reprinted at a low cost. Therefore, the above method cannot reliably distinguish legitimate products, which is costly for the companies affected; costing companies millions of US dollars due to losses from counterfeiting every year. Since anti-counterfeiting tags increase the cost of production for companies by failing to adequately protect against counterfeiting, further improvement of this method is required.

In another example, an anti-counterfeiting method is implemented by adding a machine-readable code, such as a bar code into a security tag. This security tag can be applied to many different types of goods and can be quickly read utilizing a bar code scanner. However, this anti-counterfeiting method suffers from similar deficiencies as methods using laser anti-counterfeiting tags, since security tags with machine-readable codes may easily be counterfeited by simply printing a similar tag.

Further, the anti-counterfeiting method using a bar code requires that the scanned bar code be compared with security data stored in a database. However, this method requires the incorporation of the latest data from product manufacturers. Thus, such a method has limited flexibility and cannot be easily modified for different situations.

The methods considered above suffer from the same disadvantages, since they cannot achieve the goal of providing low-cost anti-counterfeiting measures that are not easily reproducible.

### BRIEF SUMMARY OF THE INVENTION

An ink-marking type anti-counterfeiting method disclosed in the present application at least comprises the following steps.

Providing a first ink, which comprises a contrast enhancer and a reducing solution with a first concentration, and drawing an anti-counterfeiting mark on a target object? The anti-counterfeiting mark cannot be visually identified.

Then, providing a second ink, which comprises a metallic solution with a second concentration, and coating the second ink on the target object to cover an area where the anti-counterfeiting mark located. A plurality of metal nanoparticles is formed by reducing the metallic solution from the reducing solution adhered on the surface of the anti-counterfeiting mark. By the reaction of the second ink with the contrast enhancer, the pattern of the anti-counterfeiting mark can be revealed.

The anti-counterfeiting mark can be identified by the shape of a predetermined pattern. The size and the density of metal nanoparticles on the surface of anti-counterfeiting mark also can be identified by the predetermined metal nanoparticles with the first concentration, to check whether the anti-counterfeiting mark is counterfeit.

Furthermore, a Raman spectrum distribution of object surface that has the metal nanoparticles can be identified by the predetermined composition of object surface, to check whether the target object is counterfeit.

The present invention also provides an ink-marking type anti-counterfeiting implement, which comprises a marking element and a detecting element.

The marking element is filled with a first ink, and the first ink has a contrast enhancer and a reducing solution with a first concentration. The detecting element is filled with a second ink, and the second ink has a metallic solution with a second concentration, wherein the metallic solution is able to be reduced into the metal nanoparticles by the reducing solution.

Preferably, the ink-marking type anti-counterfeiting implement provided in the present invention is a pen, wherein the marking element and the detecting element are two nibs of the pen, and the one nib of the detecting element is wider than the other one nib of the marking element.

The features and advantages of the present invention will be understood and illustrated in the following specification and FIGS. 1-5.

### BRIEF DESCRIPTION OF THE DRAWINGS

FIG. 1 is a flow chart showing an ink-marking type anti-counterfeiting method;

FIG. 2 shows the results of reactions between lecithin solution and chloroauric acid solution in different concentrations;

FIG. 3A and FIG. 3B are SEM images showing gold nanoparticles on the surface of the anti-counterfeiting mark;

FIG. 4 is a Raman spectrum on the object surface of the target object that has the metal nanoparticles thereon according; and

FIG. 5 is a structure drawing showing an anti-counterfeiting implement.

### DETAILED DESCRIPTION OF THE INVENTION

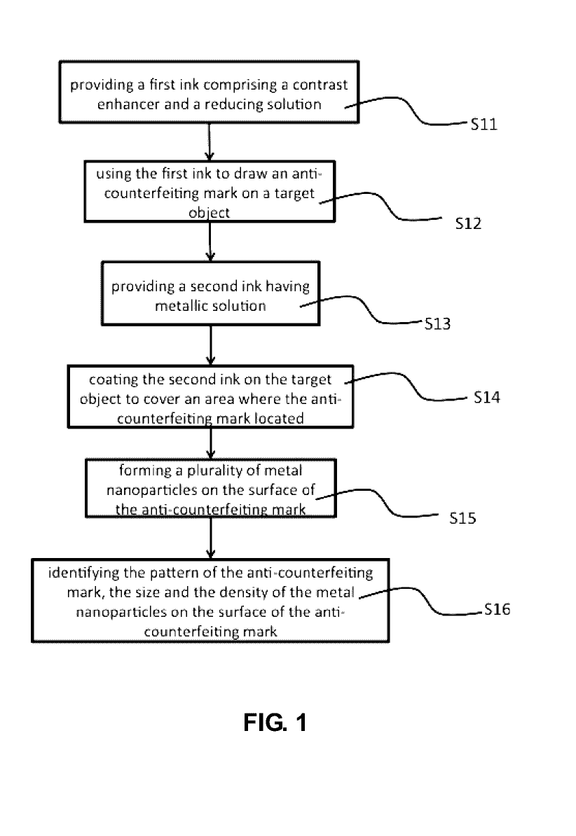

Please refer to FIG. 1, which is a flow chart showing an ink-marking type anti-counterfeiting method. In step S11, a first ink is used to manufacture an anti-counterfeiting mark. The first ink comprises a contrast enhancer and a reducing solution with a first concentration. Then, the first ink is used for drawing the anti-counterfeiting mark on a target object as shown in step S12. At that time, the anti-counterfeiting mark cannot be visually identified.

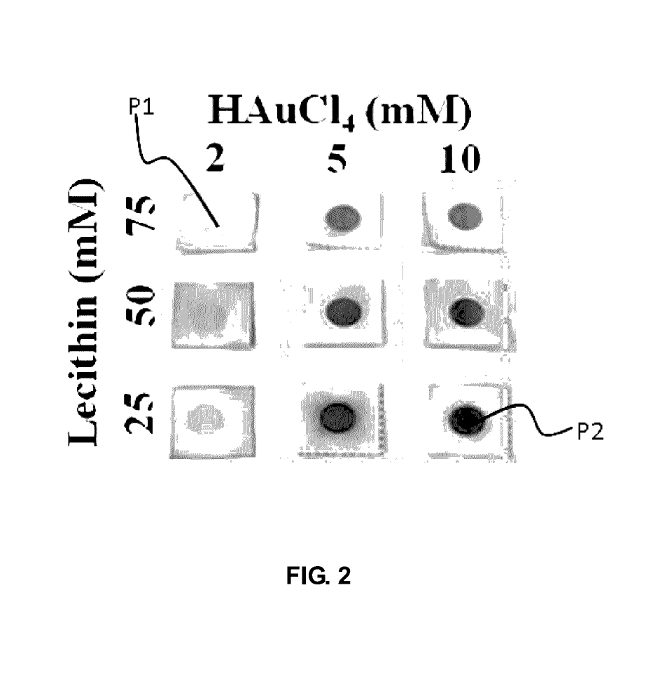

In an embodiment, a printer cartridge filled with the first ink is inserted into a printer. It can be utilized to print patterns on a paper in any shape and size (namely the above target object) as shown in FIG. 2. In another embodiment, the first ink is filled into a pen, and the pen is utilized to write a signature on any target object. At that time, the signature is the anti-counterfeiting mark, and the target object can be a paper, a metal, or a biological object, etc, particularly, the surface of a vegetable or fruit. In another embodiment, a fingerprint can be used as the anti-counterfeiting mark. However, these are non-limiting examples.

The detection of the anti-counterfeiting mark is illustrated as shown in step S13. This step comprises providing a second ink having a metallic solution with a second concentration, and then coating the second ink on the target object to cover an area where the anti-counterfeiting mark located, wherein the metallic solution is able to be reduced into metal nanoparticles by the reducing solution.

The anti-counterfeiting mark on the target object is drawn by the first ink comprising the reducing solution. After the target object is coated the second ink for a time, metal ions will be gradually reduced into a plurality of metal nanoparticles, and a layer of metal nanoparticles will be formed in-situ on the surface of the anti-counterfeiting mark. By the reaction of the second ink with the contrast enhancer, the pattern of the anti-counterfeiting mark can be revealed.

In an embodiment, the second ink is filled into a pen, and then coated onto the area of the target object where the anti-counterfeiting mark is located. In another embodiment, the target object having the anti-counterfeiting mark, such as a paper, can be dipped into the second ink. However, these are non-limiting examples.

Please refer to Table 1 below. Table 1 shows different metallic solutions, corresponding to the different of reducing solutions and specific metal nanoparticles formed on the surface of the anti-counterfeiting mark. As shown in Table 1, (1) lecithin solution, (2) sodium citrate (Na₃C₆H₅O₇) solution and (3) sodium hydroxide (NaOH) solution can be chosen as the reducing solution when the metallic solution is chloroauric acid solution (HAuCl₄.3H₂O). A layer of gold nanoparticles can be formed in-situ on the surface of the anti-counterfeiting mark. Alternatively, (4) sodium citrate (Na₃C₆H₅O₇) solution and (5) sodium borohydride (NaBH₄) solution can be chosen as the corresponding reducing solution when the metallic solution is silver nitrate (AgNO₃) solution. A layer of silver nanoparticles can be formed in-situ on the surface of the anti-counterfeiting mark. However, these are non-limiting examples.

TABLE 1

| | metallic solution | reducing solution | metal nanoparticles |
|---|---|---|---|
| (1) | HAuCl₄•3H₂O | Lecithin | Au |
| (2) | HAuCl₄•3H₂O | Na₃C₆H₅O₇ | Au |
| (3) | HAuCl₄•3H₂O | NaOH | Au |
| (4) | AgNO₃ | Na₃C₆H₅O₇ | Ag |
| (5) | AgNO₃ | NaBH₄ | Ag |

Preferably, the present invention provides a embodiment of the ink-marking type anti-counterfeiting method, wherein the reducing solution is lecithin solution with the first concentration varied from 10 mM to 100 mM, and the metallic solution is chloroauric acid solution (HAuCl₄.3H₂O) with the second concentration varied form 2 mM to 10 mM. The anti-counterfeiting mark on the target object is drawn by the first ink comprising lecithin solution, so that ionic gold (Au³⁺) in the second ink will be reduced into a plurality of gold nanoparticles by lecithin solution, and a layer of gold nanoparticles will be formed in-situ on the anti-counterfeiting mark.

Preferably, the contrast enhancer is a potassium iodide (KI) solution when the reducing solution is lecithin solution and the metallic solution is chloroauric acid solution. In this embodiment, the concentration of KI solution is 100 mM.

Please refer to FIG. 2, which shows the results of the reaction between lecithin solution and chloroauric acid solution at different concentrations. As shown in this figure, the pattern becomes purple due to the reaction between chloroauric acid and KI. The lecithin solution used as the reducing solution can reduce the partial ionic gold of the chloroauric acid solution in a few seconds. Therefore, all ionic gold of the chloroauric acid solution will be reduced after 2 hours to 24 hours.

As shown in step S16, the anti-counterfeiting mark can be identified by the shape of a predetermined pattern. The size and the density of metal nanoparticles on the surface of anti-counterfeiting mark can also be identified by the predetermined metal nanoparticles with the first concentration, to check whether the anti-counterfeiting mark is an original mark drawn by the first ink with the predetermined first concentration.

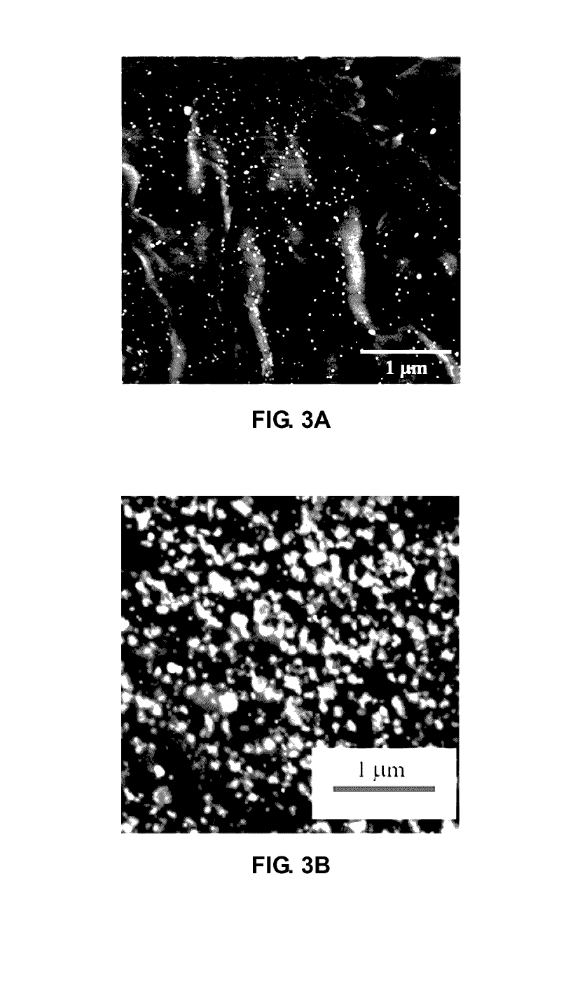

Please refer to FIG. 2 and FIG. 3. FIG. 3A and FIG. 3B, which are SEM images showing gold nanoparticles on the surface of the anti-counterfeiting mark. As shown in FIG. 2, the density of the gold nanoparticles in the unit area is higher when the concentration of the lecithin solution is higher. In addition, the size of the gold nanoparticles is larger when the concentration of the chloroauric acid solution is higher. For example, the SEM images of the gold nanoparticles P1 formed by reacting 75 mM of the lecithin solution with 2 mM of the chloroauric acid solution, and the SEM images of the gold nanoparticles P2 formed by reacting 25 mM of the lecithin solution with 10 mM of the chloroauric acid solution, are shown as FIG. 3A and FIG. 3B. Clearly, the size of the gold nanoparticles P2 formed by utilizing 10 mM of the chloroauric acid solution is larger than the size of the gold nanoparticles P1 formed by utilizing 2 mM of the chloroauric acid solution.

In addition, a Raman spectrum distribution of an object surface including the metal nanoparticles can be identified by the predetermined composition of object surface to check whether the target object is counterfeit.

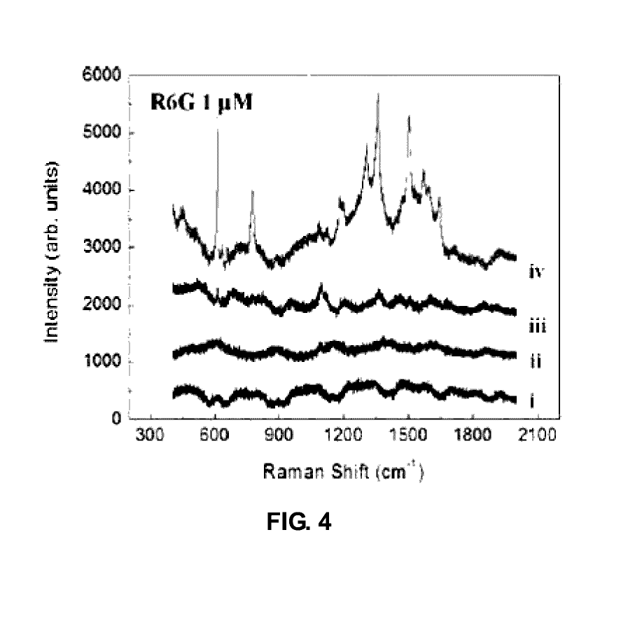

Please refer to FIG. 4, which is a Raman spectrum of an area having the anti-counterfeiting mark. A plain paper and a paper having gold nanoparticles are used as two comparative objects in (i) and (ii). A paper coated with Rhodamine 6G (“R6G” hereinafter) and a paper coated with R6G and gold nanoparticles are used as two target objects. It is known by comparing curve (iii) with curves (i) and (ii) that the target object without gold nanoparticles is difficult to be distinguished from the comparative object. However, curve (iv) shows strong fingerprint signals at 612, 774, 1363 cm⁻¹ when the target object has gold nanoparticles. Therefore, the detector can clearly determine whether the target object is the original object.

Accordingly, the present invention provides a three-stage anti-counterfeiting technology. The first stage is to check whether the anti-counterfeiting mark, such as the fingerprint or the signature, matches the registry information. The second stage is to check the size and the density of the gold nanoparticles formed in different concentrations of the anti-counterfeiting ink (namely the first ink) and the anti-counterfeiting detecting ink (namely the second ink), to exclude the risk of the counterfeit signature. The third stage is to check the Raman signal for determining whether the target object is the original object. In comparison to the prior art, the present anti-counterfeiting detector utilizes the optical apparatus, such as microscopy and Raman spectroscopy, to confirm the above three stages, thereby increasing the possibility of detecting a counterfeit.

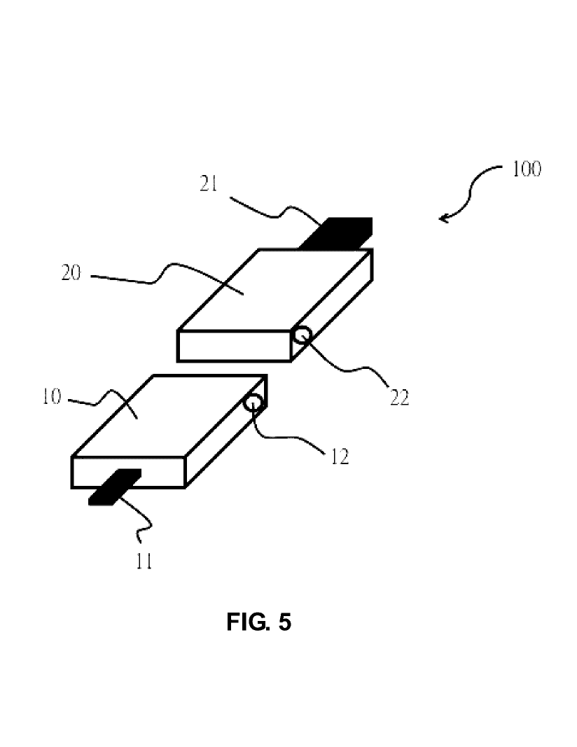

Please refer to FIG. 5, which is a structure drawing showing an anti-counterfeiting implement. The anti-counterfeiting implement 100 comprises a marking element 10 and a detecting element 20, such as two pens, a combination of a pen and a spray atomizer, a combination of a printer and a pen, etc. The marking element 10 is filled with a first ink, wherein the first ink has a contrast enhancer and a reducing solution with a first concentration. The detecting element 20 is filled with a second ink, wherein the second ink has a metallic solution with a second concentration.

Preferably, the present invention provides an embodiment of the ink-marking type anti-counterfeiting implement, wherein the ink-marking type anti-counterfeiting implement 100 is a pen, and the marking element 10 and the detecting element 20 are at opposite ends of the pen. Therefore, the anti-counterfeiting implement 100 is a pen having two nibs. Furthermore, the nib 22 of the detecting element 20 is wider than the nib 12 of the marking element 10. As a result, one can easily coat the second ink on a target object for covering an area having the anti-counterfeiting mark.

In an embodiment, the marking element 10 is one end of the pen, the first ink comprising lecithin solution and KI solution can be filled into the chamber of marking element 10 through a filling hole 11. And the viscosity of lecithin solution is higher, so that the marking element is configured with a bead, and the lecithin solution may be adhered to the bead for writing. The marking element 10 further comprises a stirring device to prevent the solution from precipitation in the marking element.

Furthermore, the detecting element 20 is the other end of the pen, with the second ink comprising chloroauric acid solution which can be filled into the chamber of detecting element 20 through a filling hole 22. The viscosity of chloroauric acid solution is lower, so that when the nib of the detecting element is a porous material, chloroauric acid solution may be adsorbed by the porous material for writing. The detecting element 20 further comprises the stirring device

To sum up, the present invention utilizes the reducing solution to manufacture the anti-counterfeiting mark on the target object, wherein the size and the density of the metal nanoparticles are directly proportional to the concentration of the reducing solution and the metallic solution to achieve a three-stage anti-counterfeiting technology. On the macro scale, two similar patterns created by man or machine may look the same. However, in the micro-scale (under a microscope, electron microscope), the patterns will be different. Therefore, the anti-counterfeiting mark manufactured according to the present invention is unique and irreproducible. Furthermore, an anti-counterfeiting implement provided in present application, such as a pen, can be applied not only to a generic object, such as a bill or a check, but also a biological object, such as vegetables or meat, for increasing the practicability and the popularity of the device.

Although the present invention has been described in detail with reference to certain preferred embodiments thereof, the disclosure is not for limiting the scope of the invention. People having ordinary skill in the art may make various modifications and changes without departing from the scope and spirit of the invention. Therefore, the scope of the appended claims should not be limited to the description of the preferred embodiments described above.

1. An ink-marking type anti-counterfeiting method, at least comprising:
providing a first ink having a contrast enhancer and a reducing solution with a first concentration;
using the first ink to draw an anti-counterfeiting mark on a target object;
providing a second ink having a metallic solution with a second concentration; and
coating the second ink on the target object to cover an area where the anti-counterfeiting mark located for forming a plurality of metal nanoparticles on the surface of the anti-counterfeiting mark,
wherein the metallic solution is able to be reduced into the metal nanoparticles by the reducing solution.

2. The anti-counterfeiting method according to claim 1 further comprising:
identifying the pattern of the anti-counterfeiting mark, and
identifying the size and the density of the metal nanoparticles on the surface of the anti-counterfeiting mark.

3. The anti-counterfeiting method according to claim 1 further comprising:
identifying a Raman spectrum distribution of object surface that has the metal nanoparticles.

4. The anti-counterfeiting method according to claim 1, wherein the reducing solution is selected from a group consisting of lecithin solution, sodium citrate solution and sodium hydroxide solution, and when the metallic solution is chloroauric acid solution, and the metallic solution is able to be reduced into a plurality of gold nanoparticles by the reducing solution.

5. The anti-counterfeiting method according to claim 4, wherein the metallic solution is chloroauric acid solution with the second concentration varied from 2 mM to 10 mM, when the reducing solution is lecithin solution with the first concentration varied from 10 mM to 100 mM, and the contrast enhancer is potassium iodide solution.

6. The anti-counterfeiting method according to claim 1, wherein the reducing solution is selected from a group consisting of sodium citrate solution and sodium borohydride solution, and when the metallic solution is silver nitrate solution, and the metallic solution is able to be reduced into a plurality of silver nanoparticles by the reducing solution.

7. An ink-marking type anti-counterfeiting implement, comprising:
a marking element filled with a first ink having a contrast enhancer and a reducing solution with a first concentration; and
a detecting element filled with a second ink having a metallic solution with a second concentration,
wherein the metallic solution is able to be reduced into the metal nanoparticles by the reducing solution.

8. The anti-counterfeiting implement according to claim 7, wherein the reducing solution is selected from a group consisting of lecithin solution, sodium citrate solution and sodium hydroxide solution, and when the metallic solution is chloroauric acid solution, the metallic solution is able to be reduced into a plurality of gold nanoparticles by the reducing solution.

9. The anti-counterfeiting implement according to claim 8, wherein the metallic solution is chloroauric acid solution with the second concentration varied from 2 mM to 10 mM, and when the reducing solution is lecithin solution with the first concentration varied from 10 mM to 100 mM, and the contrast enhancer is potassium iodide solution.

10. The anti-counterfeiting implement according to claim 7, wherein the reducing solution is selected from a group consisting of sodium citrate solution and sodium borohydride solution, and when the metallic solution is silver nitrate solution, and the metallic solution is able to be reduced into a plurality of silver nanoparticles by the reducing solution.

11. An ink-marking type anti-counterfeiting pen, comprising:
a marking nib filled with a first ink having a contrast enhancer and a reducing solution with a first concentration; and
a detecting nib filled with a second ink having a metallic solution with a second concentration,
wherein the metallic solution is able to be reduced into the metal nanoparticles by the reducing solution.

12. The ink-marking type anti-counterfeiting pen according to claim 11, wherein the reducing solution is selected from a group consisting of lecithin solution, sodium citrate solution and sodium hydroxide solution, and when the metallic solution is chloroauric acid solution, the metallic solution is able to be reduced into a plurality of gold nanoparticles by the reducing solution.

13. The ink-marking type anti-counterfeiting pen according to claim 12, wherein the metallic solution is chloroauric acid solution with the second concentration varied form 2 mM to 10 mM, and when the reducing solution is lecithin solution with the first concentration varied from 10 mM to 100 mM, the contrast enhancer is potassium iodide solution.

14. The ink-marking type anti-counterfeiting pen according to claim 11, wherein the reducing solution is selected from a group consisting of sodium citrate solution and sodium borohydride solution, and when the metallic solution is silver nitrate solution, the metallic solution is able to be reduced into a plurality of silver nanoparticles by the reducing solution.

15. The ink-marking type anti-counterfeiting pen according to claim 11, wherein the reducing solution is selected from a group consisting of sodium citrate solution and sodium borohydride solution, and when the metallic solution is silver nitrate solution, the metallic solution is able to be reduced into a plurality of silver nanoparticles by the reducing solution.
